(19) United States
(12) Patent Application Publication
(10) Pub. No.: US 2026/0321824 A1
(43) Pub. Date: Oct. 15, 2026

(54) Cap Plate of Battery Cell, Battery Cell Including the Same and Manufacturing Method for Battery Cell

(71) Applicant: SK On Co., Ltd., Seoul (KR)

(72) Inventors: Jong Hun PARK, Daejeon (KR); Byung Mook KIM, Daejeon (KR); Mi So RHO, Daejeon (KR); Kyung Tae PARK, Daejeon (KR); Byeong Hyeon PARK, Daejeon (KR); Yong Seok LEE, Daejeon (KR)

(21) Appl. No.: 19/641,689

(22) Filed: Apr. 8, 2026

(30) Foreign Application Priority Data
Apr. 11, 2025 (KR) 10-2025-0047540

(51) Int. Cl. H01M 50/152; H01M 50/171; H01M 50/645

(52) U.S. Cl. CPC H01M 50/152; H01M 50/171; H01M 50/645

(57) ABSTRACT

A cap plate of a battery cell, a battery cell including the same, and a manufacturing method for a battery cell are disclosed. In some implementations, a cap plate of a battery cell according to an embodiment of the present disclosure includes a plate body region; and a sidewall region recessed in the plate body region to form an electrolyte injection hole and having open end portions, in which at least one of the sidewall region and the plate body region may include at least one notch. According to one aspect of the present disclosure, there may be provided a cap plate for a battery cell capable of improving gas removal efficiency within a battery cell, a battery cell including the same, and a manufacturing method for a battery cell.

### CROSS-REFERENCE TO RELATED APPLICATION(S)

This patent document claims the priority and benefits of Korean Patent Application No. 10-2025-0047540 filed on Apr .11, 2025, the disclosure of which is incorporated herein by reference in its entirety.

### TECHNICAL FIELD

The present disclosure relates to a cap plate of a battery cell, a battery cell including the same, and a manufacturing method for a battery cell.

### BACKGROUND

Batteries are widely used not only in small electronic devices such as mobile phones and notebook computers but also in medium- and large-sized mechanical devices such as electric vehicles (EVs), and have the advantage of being rechargeable and reusable.

An electrode assembly may include electrode plates including a positive electrode plate and a negative electrode plate, and a separator separating the positive electrode plate and the negative electrode plate. A battery cell may be manufactured by accommodating an electrode assembly manufacture in a stack type, a stack-folding type, or a winding type together with an electrolyte in a case selected according to the intended use, such as a pouch-type, prismatic-type, or cylindrical-type case, and sealing the case.

A battery cell undergoes an activation process, and gas may be generated within the battery cell during the activation process. In this case, the generated gas may need to be removed.

### SUMMARY

The present disclosure can be implemented in some embodiments to provide a cap plate for a battery cell capable of improving gas removal efficiency within a battery cell, a battery cell including the same, and a manufacturing method for a battery cell.

The present disclosure can be implemented in some embodiments to provide a cap plate for a battery cell capable of improving the efficiency of a battery cell manufacturing process and the quality of the battery cell, a battery cell including the same, and a manufacturing method for a battery cell.

Furthermore, the present disclosure may be widely applied in green technology fields such as solar power generation and wind power generation.

Furthermore, the present disclosure may be applied to eco-friendly devices such as eco-friendly electric vehicles and hybrid vehicles that suppress air pollution and greenhouse gas emissions to prevent climate change.

In some embodiment of the present disclosure, a cap plate of a battery cell includes a plate body region; and a sidewall region recessed in the plate body region to form an electrolyte injection hole and having open end portions, in which at least one of the sidewall region and the plate body region may include at least one notch.

In one embodiment, the cap plate may further include: a plurality of notches, in which the plurality of notches may be formed in the sidewall region and the plate body region and formed in a circumferential direction of the sidewall region.

In an embodiment, the plurality of notches may be spaced apart from each other in the circumferential direction of the sidewall region.

In an embodiment, a shape of the at least one notch in a cross-section of the sidewall region in a thickness direction may be a polygon.

In an embodiment, a shape of the at least one notch in a cross-section of the sidewall region in a thickness direction may be an arc.

In an embodiment, the end portions of the sidewall region may include: a first open end portion connected to the plate body region; and a second open end portion spaced apart from the first open end portion, and the sidewall region may include a sidewall body portion connecting the first open end portion and the second open end portion and forming a hollow portion.

In an embodiment, a width of the first open end portion may be wider than that of the second open end portion.

In an embodiment, at least a partial region of the at least one notch may be disposed at the same height as the first open end portion.

In an embodiment, the sidewall body portion may include a sealed region which is a region where the at least one notch is not formed, and the sealed region may be a region from the second open end portion to the at least one notch. Meanwhile, according to another aspect of the present disclosure, there is provided a cap plate of a battery cell.

In some embodiments of the present disclosure, a battery cell includes: a case including an accommodation space in which an electrode assembly is accommodated; a cap plate connected to the case and including an electrolyte injection hole; and a sealing member inserted into the electrolyte injection hole, in which the cap plate includes: a plate body region covering the accommodation space; and a sidewall region recessed in the plate body region to form the electrolyte injection hole and having open end portions, at least one of the sidewall region and the plate body region includes at least one notch, and the sealing member seals the electrolyte injection hole.

In an embodiment, the at least one notch may include a plurality of notches, the end portions of the sidewall region may include: a first open end portion connected to the plate body region; and a second open end portion spaced apart from the first open end portion, the sidewall region may include a sidewall body portion connecting the first open end portion and the second open end portion and forming a hollow portion, and the sealing member may be disposed in the hollow portion.

In an embodiment, the sidewall body portion may include a sealed region which is a region where a plurality of notches are not formed, the sealed region may be a region from the second open end portion to the plurality of notches, and at least a partial region of the sealing member may be in contact with the sealed region.

In an embodiment, a width of the first open end portion may be wider than a maximum width of the sealing member, and a width of the second open end portion may be narrower than the maximum width of the sealing member.

In an embodiment, a width of the hollow portion linearly may decrease toward the second open end portion.

In an embodiment, the sidewall region may further include a plurality of protruding regions alternately disposed with the plurality of notches in a circumferential direction of the sidewall region, and a sum of minimum widths of the plurality of protruding regions in the circumferential direction of the sealing member may be greater than or equal to 10% and less than or equal to 90% of a circumference value of the sealing member.

In an embodiment, a width of the plurality of notches may decrease as the plurality of notches move away from the hollow portion.

In an embodiment, the plurality of notches may each have a maximum width at a region closest to the hollow portion, and the maximum width may be greater than or equal to 0.04 mm and less than or equal to 2 mm.

In an embodiment, a depth of the plurality of notches may be greater than or equal to 0.04 mm and less than 2 mm.

Meanwhile, according to still another embodiment of the present disclosure, there is provided a manufacturing method for a battery cell.

In some embodiments of the present disclosure, a manufacturing method for a battery cell that includes a case including an accommodation space in which an electrode assembly is accommodated, a cap plate connected to the case and including an electrolyte injection hole, and a sealing member inserted into the electrolyte injection hole and sealing the electrolyte injection hole, in which the cap plate includes a plate body region covering the accommodation space, and a sidewall region recessed in the plate body region to form the electrolyte injection hole and having open end portions, and at least one of the sidewall region and the plate body region includes at least one notch, the manufacturing method including: performing a press-fitting in which the sealing member is press-fitted to a position where an outer surface of the sealing member faces the at least one notch; and performing an additionally press-fitting after the press-fitting, in which a height of the sealing member in the electrolyte injection hole is changed.

In an embodiment, the manufacturing method may further include: performing a degassing in which a voltage is applied to the battery cell while the sealing member is at a position corresponding to a position in the press-fitting.

### BRIEF DESCRIPTION OF DRAWINGS

Certain aspects, features, and advantages of the present disclosure are illustrated by the following detailed description with reference to the accompanying drawings.

FIG. 1 is a schematic cross-sectional view of a cap plate according to an embodiment of the present disclosure.

FIG. 2 is a schematic plan view of the cap plate according to an embodiment of the present disclosure.

FIG. 3 is a schematic plan view of the cap plate according to another embodiment of the present disclosure.

FIG. 4 is a schematic plan view of the cap plate according to another embodiment of the present disclosure.

FIG. 5 is a schematic cross-sectional view of a battery cell according to an embodiment of the present disclosure.

FIG. 6 is a plan view of a cap plate of a battery cell and a sealing member according to an embodiment of the present disclosure.

FIG. 7 is a plan view of the cap plate of a battery cell and the sealing member according to an embodiment of the present disclosure.

FIG. 8 is a plan view of the cap plate of a battery cell and the sealing member according to an embodiment of the present disclosure.

FIG. 9 is a diagram schematically illustrating a state in which the sealing member is inserted into an electrolyte injection hole of a battery cell according to an embodiment of the present disclosure.

FIG. 10 is a diagram schematically illustrating the state in which the sealing member is inserted into the electrolyte injection hole of the battery cell according to an embodiment of the present disclosure.

FIG. 11 is a diagram illustrating a pre-charge test result of the battery cell.

FIG. 12 is a diagram illustrating the pre-charge test result of the battery cell.

FIG. 13 is a diagram schematically illustrating a manufacturing method for a battery cell according to an embodiment of the present disclosure.

FIG. 14 is a diagram schematically illustrating the manufacturing method for a battery cell according to an embodiment of the present disclosure.

### DETAILED DESCRIPTION

Features of the present disclosure disclosed in this patent document are described by example embodiments with reference to the accompanying drawings.

To facilitate understanding of descriptions of embodiments of the present disclosure, elements denoted by the same reference numerals in the accompanying drawings are the same elements. It is to be noted that some components shown in the accompanying drawings are exaggerated, omitted or schematically illustrated, and the size of each component does not exactly reflect its real size.

Furthermore, to clarify the gist of the present disclosure, descriptions of elements and techniques well known in the art will be omitted. Hereinafter, the present disclosure will be described in detail with reference to the accompanying drawings.

Hereinafter, an X-axis illustrated in the drawings is a width direction or a length direction of a cap plate 100, a Y-axis is a thickness direction of the cap plate 100, and a Z-axis is a width direction or a length direction of the cap plate 100. However, this is a direction arbitrarily set for convenience of understanding, and the above-described directions may be changed.

In the accompanying drawings, a point at which the X-axis, the Y-axis, and the Z-axis intersect may be an origin or a zero point. In the accompanying drawings, any region may be the origin or the zero point. When an arbitrary region or point in the accompanying drawings is set as the origin or the zero point, the X-axis, the Y-axis, and the Z-axis illustrated in the drawings may maintain the same state as illustrated in the drawings with respect to the set origin or the zero point. Further, the X-axis, the Y-axis, and the Z-axis illustrated in the accompanying drawings are illustrated in a positive (+) direction, and a negative (−) direction may be understood as a direction opposite to the positive (+) direction with reference to the origin or the zero point.

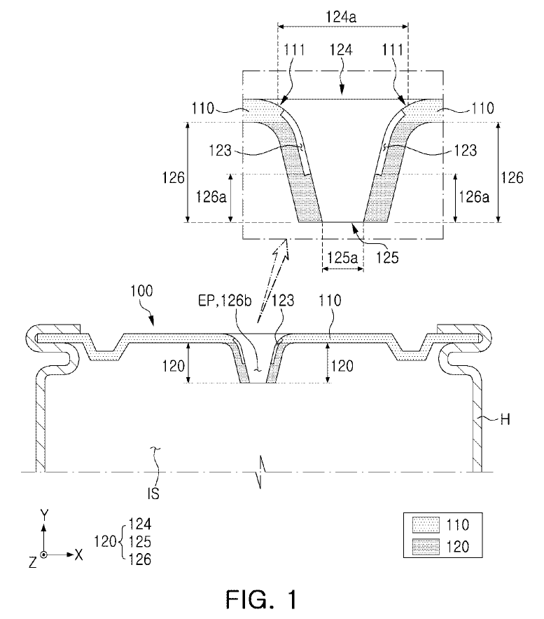

FIG. 1 is a schematic cross-sectional view of a cap plate 100 according to an embodiment of the present disclosure.

As illustrated in FIG. 1, the cap plate 100 according to an embodiment of the present disclosure may include a plate body region 110 and a sidewall region 120 recessed from the plate body region 110 to form an electrolyte injection hole EP and having open end portions. In this case, at least one of the sidewall region 120 and the plate body region 110 may include at least one notch 123.

The cap plate 100 may be in a plate form. The cap plate 100 may be formed of a material including at least one of carbon steel, stainless steel, aluminum, and nickel. The cap plate 100 may have a thin plate shape having a relatively small thickness. For example, a thickness of the cap plate 100 may have a value greater than or equal to 0.3 mm and less than or equal to 4 mm. In an embodiment, the thickness of the cap plate 100 may be 3 mm. In an embodiment, the thickness of the cap plate 100 may be 0.6mm.

The cap plate 100 may cover a housing H including a space IS. For example, the plate body region 110 of the cap plate 100 may cover or close the space IS of the housing H. The plate body region 110 may be a closed region.

The cap plate 100 may include the sidewall region 120. The sidewall region 120 may be a region recessed from the plate body region 110 in a −Y direction. The sidewall region 120 and the plate body region 110 may be partitioned based on an extension line of a lower surface of the plate body region 110.

In an embodiment, the cap plate 100 may be formed by a forming apparatus to have the sidewall region 120. For example, the forming apparatus may include any apparatus capable of metal forming, such as milling, drilling, forging, and metalworking. However, a method of forming the sidewall region 120 is not limited by the present disclosure.

In an embodiment, end portions of the sidewall region 120 may include a first open end portion 124 continuing from the plate body region 110 and a second open end portion 125 spaced apart from the first open end portion 124. In this case, the sidewall region 120 may include a sidewall body portion 126 connecting the first open end portion 124 and the second open end portion 125 and forming a hollow portion 126b.

The sidewall body portion 126 may be formed of the same material as the plate body region 110. The sidewall body portion 126 may be formed by folding or bending from the plate body region 110 in a −Y direction. For example, a connection region 111 between the sidewall body portion 126 and the plate body region 110 may be rounded.

At least a partial region of the connection region 111 may be positioned in a cross-section (an X–Y plane) of the cap plate 100 in a thickness direction and in a plane perpendicular to a cross-section (an X–Z plane) of the cap plate 100 in a thickness direction.

In an embodiment, the at least one notch 123 may include a plurality of notches 123, and the plurality of notches 123 may be formed in the sidewall body portion 126 and the connection region 111. The plurality of notches 123 may be positioned in the cross-section (the X–Y plane) of the cap plate 100 in the thickness direction and in the plane (the X–Z plane) perpendicular to the cross-section of the cap plate 100 in the thickness direction. Accordingly, the plurality of notches 123 may face an outer region of the space IS of the housing H and may communicate with the outer region. Accordingly, the plurality of notches 123 may be a passage through which gas present in the space IS of the housing H is discharged to the outside of the space IS of the housing H.

In addition, in an embodiment, at least a partial region of the at least one notch 123 may be positioned at the same height as the first open end portion 124. When the at least one notch 123 includes the plurality of notches 123, at least a partial region of at least one of the plurality of notches 123 may be positioned at the same height as the first open end portion 124. In this case, the height may be a height of the cap plate 100 in the thickness direction, that is, a height in a Y direction. Accordingly, gas in the space IS may be easily discharged to the outside of the space IS.

In an embodiment, the sidewall body portion 126 may form the hollow portion 126b. The hollow portion 126bmay be the electrolyte injection hole EP serving as a passage through which an electrolyte is injected. The sidewall body portion 126 may form an outer periphery of the hollow portion 126b.

The first open end portion 124 may allow the hollow portion 126bto communicate with an outside of the cap plate 100. The first open end portion 124 may be connected to the hollow portion 126b.

The hollow portion 126b may be connected to the first open end portion 124 and the second open end portion 125. The second open end portion 125 may be connected to the space IS of the housing H. Accordingly, the electrolyte may flow into the space IS. An electrode assembly 201, the electrolyte, and the like may exist in the space IS.

In an embodiment, a width 124a of the first open end portion 124 may be greater than a width 125a of the second open end portion 125. Accordingly, electrolyte injection efficiency may be improved.

In the cross-section (the X–Y plane) of the cap plate 100 in the thickness direction, the sidewall body portion 126 may be inclined. A width of the hollow portion 126bin an X-axis direction may be widest at the same height as the first open end portion 124 and may be narrowest at the same height as the second open end portion 125. For example, the width of the hollow portion 126bin the X-axis direction may linearly decrease toward the −Y direction.

Accordingly, the width of the hollow portion 126b may linearly decrease toward a direction toward the second open end portion 125. In this case, the width of the hollow portion 126b is a width in the X-axis direction and may be the shortest distance from one sidewall body portion 126 to the other sidewall body portion 126. Accordingly, the electrolyte injection efficiency may be improved.

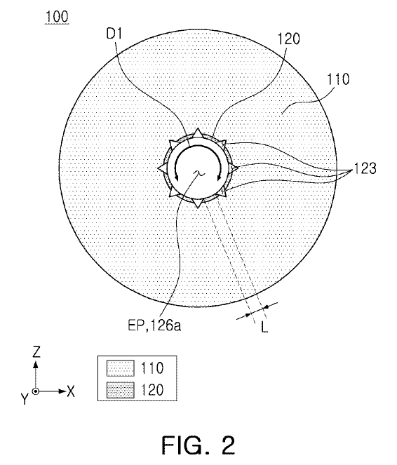

FIG. 2 schematically illustrates a plan view of the cap plate 100 according to an embodiment of the present disclosure.

As illustrated in FIG. 2, in an embodiment of the present disclosure, the hollow portion 126b and the electrolyte injection hole EP may be circular. At least a partial region of the plurality of notches 123 may be identified in a plan view of the cap plate 100. Accordingly, gas may be discharged to an outside of the cap plate 100, that is, to an outside of the space IS (FIG. 1).

In an embodiment, the plurality of notches 123 may be formed in the sidewall region 120 and the plate body region 110, and the plurality of notches 123 may be formed in a circumferential direction D1 of the sidewall region 120.

In the plane (the X–Z plane) perpendicular to the cap plate 100 in the thickness direction, an outline of the cap plate 100 may have a curve, and outlines of the hollow portion 126b and the electrolyte injection hole EP may also have a curve.

The sidewall region 120 may include the plurality of notches 123, and thus, include a space recessed from the hollow portion 126b and the electrolyte injection hole EP. Accordingly, even when a sealing ball or the like having a width at least the same as a width of the hollow portion 126b and the electrolyte injection hole EP is inserted into the hollow portion 126b and the electrolyte injection hole EP, gas may move through the plurality of notches 123.

The number of notches 123 is not necessarily limited by the present disclosure and may be appropriately changed and applied according to specifications of the cap plate 100.

In an embodiment, the plurality of notches 123 may be disposed to be spaced apart from each other in the circumferential direction of the sidewall region 120.

For example, a pair of notches 123 may have a separation distance L from each other. The number of notches 123 is not limited by the present disclosure. When the plurality of notches 123 are formed in the cap plate 100, the separation distances L between the plurality of notches 123 may be the same as each other or may be different from each other, some of the separation distances L may be the same as each other, and other separation distances L may also be the same as each other. For example, the plurality of notches 123 may be spaced apart by equal intervals.

In an embodiment, the plurality of notches 123 may have a polygonal shape in a cross-section (an X–Z plane) of the sidewall region 120 in the thickness direction. The cross-section (the X–Z plane) of the sidewall region 120 in the thickness direction and the cross-section (the X–Y plane) of the cap plate 100 or the plate body region 110 in the thickness direction may be perpendicular to or intersect each other. Accordingly, the positions of the plate body region 110 and the sidewall region 120 may be set in consideration of the relationship between the cross-sections. In addition, shapes of the plurality of notches 123 in the cross-section (the X–Z plane) of the sidewall region 120 in the thickness direction and in a plan view of the cap plate 100 may be the same. However, an area of the notch 123 in each view may be different.

In an embodiment, the plurality of notches 123 may include a straight line in the shape in the cross-section (the X-Z plane) of the sidewall region 120 in the thickness direction.

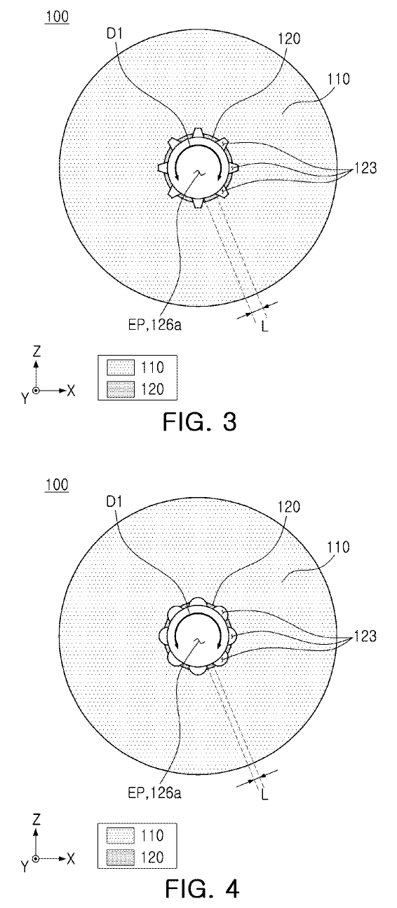

FIG. 3 schematically illustrates a plan view of a cap plate 100 according to another embodiment of the present disclosure.

As illustrated in FIG. 3, in an embodiment of the present disclosure, shapes of a plurality of notches 123 in a cross-section (X–Z plane) of a sidewall region 120 in a thickness direction may be trapezoidal. However, this is according to an embodiment, and the plurality of notches 123 may have a square shape or a rectangular shape.

Further, the plurality of notches 123 may be applied with a mixture of shapes of a triangle, a square, a rectangle, and a trapezoid.

In an embodiment, separation distances L formed between a pair of notches 123 may have the same value.

FIG. 4 schematically illustrates a plan view of the cap plate 100 according to another embodiment of the present disclosure. As illustrated in FIG. 4, in an embodiment of the present disclosure, shapes of the plurality of notches 123 in the cross-section (the X–Z plane) of the sidewall region 120 in the thickness direction may include at least one of a curve and a straight line.

For example, the plurality of notches 123 may include an arc in the shape in the cross-section (the X–Z plane) of the sidewall region 120 in the thickness direction. For example, outlines of the plurality of notches 123 may include a curve. Further, in an embodiment, the plurality of notches 123 may have a semicircular shape in the cross-section (the X–Z plane) of the sidewall region 120 in the thickness direction. Accordingly, corrosion of the cap plate 100 due to an electrolyte or the like may be minimized or prevented.

Meanwhile, as illustrated in FIG. 1, in an embodiment of the present disclosure, a sidewall body portion 126 may include a sealed region 126a, which is a region where the at least one notch 123 is not formed. In this case, the sealed region 126amay correspond to a region from the second open end portion 125 to the at least one notch 123.

The sealed region 126a may be positioned below the notch 123 in a −Y direction in a cross-section (an X–Y plane) of the sidewall body portion 126 in a thickness direction. The sealed region 126amay be disposed closer to a space IS of a housing H than the plurality of notches 123.

The sealed region 126a may be a region where the notch 123 is not formed in the sidewall body portion 126. In the sealed region 126a, a width of an electrolyte injection hole EP or a hollow portion 126b in an X direction may be narrower than that of the electrolyte injection hole EP or the hollow portion 126b in the X direction in a region where the notch 123 is present.

A sealing ball or the like may be positioned in the sealed region 126alater. By bringing an outer surface of the sealing ball into contact with the sealed region 126a, the space IS may be blocked from an outside of the cap plate 100.

In an embodiment, the separation distances L formed between a pair of notches 123 may have the same value. Further, in the embodiment illustrated in FIG. 4, the separation distances L formed between the pair of notches 123 may have a value smaller than the separation distances L illustrated in FIGS. 2 and 3.

According to another aspect, the present disclosure provides a battery cell 200 including a cap plate 100.

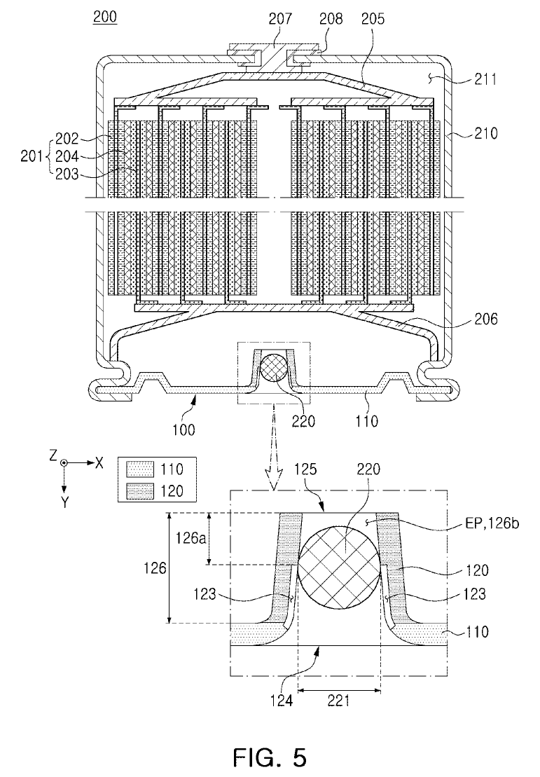

FIG. 5 is a schematic cross-sectional view of the battery cell 200 according to an embodiment of the present disclosure. In FIG. 5, detailed insulating materials and the like are omitted. The insulating material may be a material having electrical insulation.

The battery cell 200 according to an embodiment of the present disclosure may include a case 210 including an accommodation space 211 in which an electrode assembly 201 is accommodated, the cap plate 100 connected to the case 210 and including the electrolyte injection hole EP, and a sealing member 220 inserted into the electrolyte injection hole EP. Here, the cap plate 100 includes a plate body region 110 covering the accommodation space 211 and the sidewall region 120 recessed from the plate body region 110 to form the electrolyte injection hole EP and having open end portions, at least one of the sidewall region 120 and the plate body region 110 includes at least one notch 123, and the sealing member 220 may seal the electrolyte injection hole EP.

In an embodiment, the cap plate 100 may be a cap plate 100 formed according to any one of the above-described embodiments or a combination of a plurality of the embodiments.

Further, the at least one notch 123 may include a plurality of notches 123. The plurality of notches 123 may be spaced apart from each other in a circumferential direction of the sidewall region 120 or in a circumferential direction of the electrolyte injection hole EP.

The accommodation space 211 may be the space IS illustrated in FIG. 1. The electrode assembly 201 and the electrolyte may be accommodated in the accommodation space 211.

In an embodiment, the case 210 may be formed of a material having electrical insulation, or the material having electrical insulation may be provided on an outer surface of the case 210. The case 210 may be cylindrical. In this case, the battery cell 200 may be the cylindrical battery cell 200. A height, a diameter, and the like of the cylindrical battery cell 200 are not limited by the present disclosure.

The electrode assembly 201 may include at least one positive electrode plate 202, at least one negative electrode plate 203, and a separator 204.

For example, the electrode assembly 201 may be formed in a rolled form by winding or rolling the positive electrode plate 202 having a relatively long length, the negative electrode plate 203 having a relatively long length, and the separator 204 while the positive electrode plate 202 and the negative electrode plate 203 overlap each other. In this case, the separator 204 may be positioned between the positive electrode plate 202 and the negative electrode plate 203.

In an embodiment, the positive electrode plate 202 may include a positive electrode active material region coated with a positive electrode active material and a positive electrode uncoated region not coated with the positive electrode active material. The positive electrode uncoated region may be bent and connected to a first current collector plate 205.

The first current collector plate 205 may be a plate having electrical conductivity and may be electrically connected to a terminal member 207. The terminal member 207 may be formed of a material having electrical conductivity, and at least a partial region thereof may be exposed to an outside of the case 210. An insulating member 208 may be provided between the terminal member 207 and the case 210, and the terminal member 207 and the case 210 may be electrically insulated from each other.

In an embodiment, the negative electrode plate 203 may include a negative electrode active material region coated with a negative electrode active material and a negative electrode uncoated region not coated with the negative electrode active material. The negative electrode uncoated region may be bent and connected to the second current collector plate 206.

The second current collector plate 206 may be a plate having electrical conductivity and may be electrically connected to the case 210.

In an embodiment, the battery cell 200 may be a tabless cylindrical battery cell 200.

The cap plate 100 may be disposed to face the terminal member 207. The cap plate 100 may be connected to the case 210 and may cover the accommodation space 211 of the case 210.

For example, the plate body region 110 of the cap plate 100 may cover the accommodation space 211. The cap plate 100 may be welded to the case 210.

A sealing member 220 may be inserted into the electrolyte injection hole EP or the hollow portion 126b. The sealing member 220 may be formed of the same material as the cap plate 100. For example, the sealing member 220 may be formed of a material including at least one of carbon steel, stainless steel, aluminum, and nickel.

The sealing member 220 may have a sphere. However, a shape of the sealing member 220 is not necessarily limited by the present disclosure and may be appropriately changed and applied according to specifications of the battery cell 200 or the like.

In an embodiment, end portions of the sidewall region 120 may include a first open end portion 124 connected to the plate body region 110 and a second open end portion 125 spaced apart from the first open end portion 124. The second open end portion 125 may be disposed to face or communicate with the accommodation space 211. The first open end portion 124 may be disposed to face or communicate with an outside of the accommodation space 211.

Further, the sidewall region 120 may include a sidewall body portion 126 connecting the first open end portion 124 and the second open end portion 125 and forming the hollow portion 126b, and the sealing member 220 may be disposed in the hollow portion 126b.

The hollow portion 126b may be a passage through which an electrolyte is injected. The plurality of notches 123 may face the hollow portion 126bor the electrolyte injection hole EP.

The sealing member 220 may be disposed in the hollow portion 126b, and at least a partial region of an outer surface of the sealing member 220 may contact the sidewall body portion 126. Further, another partial region of the outer surface of the sealing member 220 may face the notch 123. Accordingly, a gap may be formed between the outer surface of the sealing member 220 and the sidewall region 120. The gap may be a flow passage of a gas.

In an embodiment, the sidewall body portion 126 may include a sealed region 126ain which the plurality of notches 123 are not formed, and the sealed region 126a may be a region from the second open end portion 125 to the plurality of notches 123. In this case, at least a partial region of the sealing member 220 may contact the sealed region 126a.

After gas removal is completed in the battery cell 200, at least a partial region of the sealing member 220 may be in a state of contacting the sealed region 126a. Further, at least a partial region of the sealing member 220 may be positioned in the hollow portion 126bsurrounded by the sealed region 126a. Accordingly, the accommodation space 211 (IS) may be blocked from the outside of the case 210 and the cap plate 100, and the electrolyte injection hole EP may be sealed. In this case, a flow of gas may be impossible, and leakage of the electrolyte from the accommodation space 211 (IS) may be prevented.

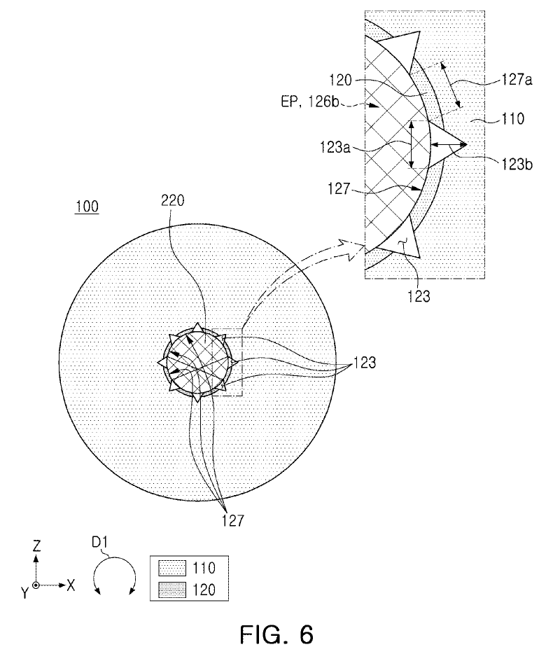

FIG. 6 is a plan view of the cap plate 100 and the sealing member 220 of the battery cell 200 according to an embodiment of the present disclosure.

As illustrated in FIGS. 5 and 6, in an embodiment of the present disclosure, the plurality of notches 123 may be disposed along a circumferential direction D1 of the hollow portion 126b or the electrolyte injection hole EP. The plurality of notches 123 may have a polygonal shape in a cross-section of the sidewall region 120 in a thickness direction. For example, the plurality of notches 123 may have a triangular shape in the cross-section of the sidewall region 120 in the thickness direction.

In an embodiment, widths of the plurality of notches 123 may decrease as the plurality of notches 123 move away from the hollow portion 126b. A minimum width of the plurality of notches 123 may be spaced farthest from the hollow portion 126b.

Further, in an embodiment, regions having a maximum width of the plurality of notches 123 may be disposed closest to the hollow portion 126b. For example, regions having a maximum width 123aof the plurality of notches 123 may face the hollow portion 126b. In an embodiment, when a thickness of the cap plate 100 or a thickness of the plate body region 110 is greater than or equal to 2 mm and less than or equal to 4 mm, the maximum width 123a of the plurality of notches 123 may have a value of 0.04 mm or greater and 2 mm or less. Further, a depth 123b of the plurality of notches 123 may be greater than or equal to 0.04 mm and less than 2 mm. Accordingly, gas may be smoothly discharged from the accommodation space 211, while preventing the volatilization of the electrolyte supplied to the accommodation space 211.

For example, the number of notches 123 may be determined within a range of 1 or greater and 250 or less, but the number of notches 123 is not necessarily limited by the present disclosure.

In an embodiment, when a thickness of the cap plate 100 or a thickness of the plate body region 110 is greater than or equal to 0.05 mm and less than or equal to 4 mm, a maximum width 123a of the plurality of notches 123 may be greater than or equal to 0.04 mm and less than 2 mm. The maximum width 123aof the notch 123 may be determined according to the thickness of the cap plate 100.

In an embodiment, when the thickness of the cap plate 100 or the thickness of the plate body region 110 is greater than or equal to 2 mm and less than or equal to 4 mm, the maximum width 123a of the plurality of notches 123 may be greater than or equal to 0.58 mm and less than or equal to 1.16 mm. In this case, a depth 123bof the plurality of notches 123 may be greater than or equal to 0.5 mm and less than or equal to 1 mm.

Further, in an embodiment, when the thickness of the cap plate 100 or the thickness of the plate body region 110 is greater than or equal to 0.5 mm and less than or equal to 0.7 mm, the maximum width 123aof the plurality of notches 123 may be greater than or equal to 0.04 mm and less than or equal to 1 mm. In this case, the depth 123bof the plurality of notches 123 may be greater than or equal to 0.04 mm and less than or equal to 0.5 mm.

For example, when the thickness of the cap plate 100 or the thickness of the plate body region 110 is 0.6 mm, the depth 123bof the plurality of notches 123 may have a value of 0.04 mm or greater and 0.5 mm or less. In this case, the maximum width 123aof the plurality of notches 123 may have a value of 0.04 mm or greater and 1 mm or less.

For example, when the thickness of the cap plate 100 or the thickness of the plate body region 110 is 0.6 mm, the maximum width 123aof the plurality of notches 123 may be greater than or equal to 0.058 mm and less than or equal to 0.8 mm. Furthermore, the depth 123b of the plurality of notches 123 may have a value of 0.05 mm or greater and 0.4 mm or less.

Accordingly, even in the cap plate 100 having a relatively thin plate, it is possible to smoothly discharge gas from the accommodation space 211 while preventing the volatilization of the electrolyte supplied to the accommodation space 211. In an embodiment, the sidewall region 120 may further include a plurality of protruding regions 127 alternately disposed with the plurality of notches 123 in a circumferential direction D1 of the sidewall region 120. In this case, a sum of minimum widths 127aof the plurality of protruding regions 127 in a circumferential direction of the sealing member 220 may be greater than or equal to 10% and less than or equal to 90% of a circumference value of the sealing member 220. For example, the sum of the minimum widths 127aof the plurality of protruding regions 127 in the circumferential direction of the sealing member 220 may be greater than or equal to 15% and less than or equal to 88%.

Further, in an embodiment, the number of notches 123 may be greater than or equal to 4 and less than or equal to 80. According to the above description, it is possible to smoothly discharge gas while preventing the sealing member 220 from being separated from the hollow portion 126b or the electrolyte injection hole EP.

The circumferential direction D1 of the sidewall region 120 may be the same direction as the circumferential direction of the sealing member 220.

The protruding region 127 may be disposed between a pair of notches 123. The plurality of protruding regions 127 may contact the outer surface of the sealing member 220. Accordingly, in an embodiment, by allowing the sum of the minimum widths 127a of the plurality of protruding regions 127 in the circumferential direction of the sealing member 220 to be greater than or equal to 30% and less than or equal to 50% of the circumference value of the sealing member 220, the separation of the sealing member 220 from the hollow portion 126b or the electrolyte injection hole EP may be prevented even at a position where the sealing member 220 faces the plurality of notches 123.

The sum of the minimum widths 127a of the plurality of protruding regions 127 may be represented as a product of a value of the minimum width 127a of one protruding region 127 and the number of protruding regions 127. This corresponds to a case where the values of the minimum widths 127a of the plurality of protruding regions 127 are all identical. When the values of the minimum widths 127aof the plurality of protruding regions 127 are different from each other, the sum of the minimum widths 127a of the plurality of protruding regions 127 may be a value obtained by summing all of the minimum widths 127a of the plurality of protruding regions 127.

The plurality of protruding regions 127 may be portions corresponding to relief of the sidewall region 120, and the plurality of notches 123 may be portions corresponding to intaglio of the sidewall region 120.

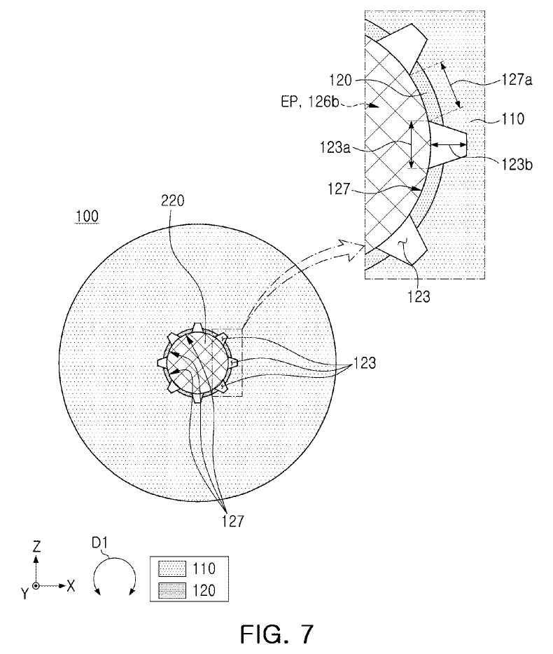

FIG. 7 is a plan view of the cap plate 100 and the sealing member 220 of the battery cell 200 according to an embodiment of the present disclosure.

As illustrated in FIGS. 5 and 7, in an embodiment of the present disclosure, the shapes of the plurality of notches 123 may be trapezoidal. In this case, the region having the minimum width 123a in each notch 123 may face the hollow portion 126b.

The sealing member 220 may be inserted into the hollow portion 126band may be disposed at a position facing either the plurality of notches 123 or the sealed region 126a depending on a process step.

The gas in the accommodation space 211 may be discharged to the outside of the case 210 at a position where the sealing member 220 faces the plurality of notches 123, and the discharge of the gas and an electrolyte in the accommodation space 211 to the outside of the case 210 may be prevented or minimized at a position where the sealing member 220 faces the sealed region 126a.

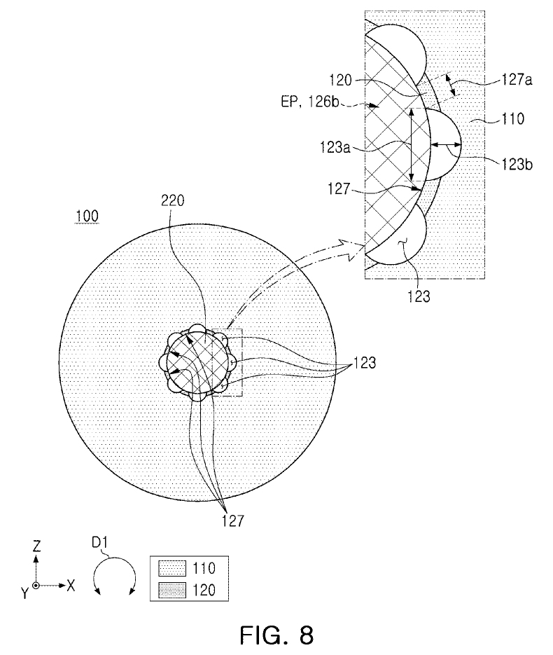

FIG. 8 is a plan view of the cap plate 100 and the sealing member 220 of the battery cell 200 according to an embodiment of the present disclosure.

As illustrated in FIG. 8, in an embodiment of the present disclosure, the shapes of the plurality of notches 123 in the cross-section (the X-Z plane) of the sidewall region 120 in the thickness direction may be semicircular.

In this case, the corrosion of the cap plate 100 caused by the electrolyte or the like may be prevented or minimized.

Meanwhile, as illustrated in FIG. 5, in an embodiment of the present disclosure, a width of the first open end portion 124 in the X direction may be greater than a maximum width 221 of the sealing member 220, and a width of the second open end portion 125 in the X direction may be smaller than the maximum width 221 of the sealing member 220. In this case, a width of the hollow portion 126b in the X direction or the electrolyte injection hole EP may gradually decrease in a direction toward the second open end portion 125. That is, the width of the hollow portion 126b in the X direction or the electrolyte injection hole EP may linearly decrease in a direction toward the second open end portion 125.

Accordingly, the width of the hollow portion 126b in the X direction or the electrolyte injection hole EP may have multiple values. In this case, the hollow portion 126bor the electrolyte injection hole EP may include a region having a width equal to the maximum width 221 of the sealing member 220 in the X direction.

Therefore, the sealing member 220 may be easily inserted into the first open end portion 124, the sealing member 220 may be maintained in a position within the hollow portion 126b or the electrolyte injection hole EP, and the sealing member 220 may be prevented from passing through the second open end portion 125 and dropping into the accommodation space 211.

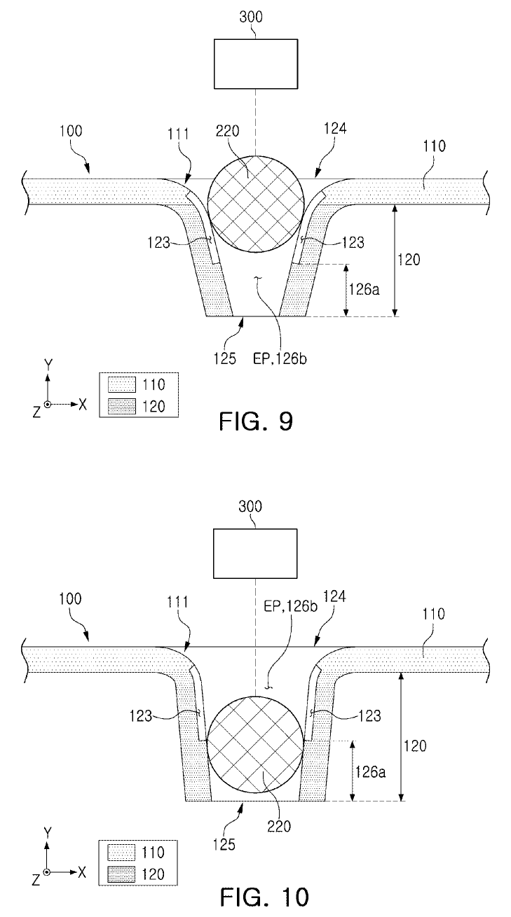

FIG. 9 schematically illustrates a state in which the sealing member 220 is inserted into the electrolyte injection hole EP of the battery cell 200 according to an embodiment of the present disclosure.

The sealing member 220 may be press-fitted into the electrolyte injection hole EP by the pressing device 300.

The pressing device 300 may press-fit the sealing member 220 to a position where at least a portion of the outer surface of the sealing member 220 faces the plurality of notches 123. In this case, the width of the first open end portion 124 in the X direction may be greater than or equal to 6 mm and less than or equal to 12 mm. In addition, the width of the second open end portion 125 in the X direction may be greater than or equal to 3 mm and less than or equal to 6 mm. In this case, the maximum width of the sealing member 220 in the X direction may be greater than or equal to 4 mm and less than or equal to 9 mm.

For example, when the maximum width of the sealing member 220 is 4 mm, the width of the second open end portion 125 in the X direction may be 3 mm, and the width of the first open end portion 124 in the X direction may be greater than or equal to 6 mm and less than or equal to 12 mm. In this case, the width of the hollow portion 126b in the X direction may linearly decrease toward the second open end portion 125.

Here, the thickness of the cap plate 100 may be greater than or equal to 0.3 mm and less than or equal to 2 mm, as described above. Considering such a thickness of the cap plate 100, when the pressing device 300 press-fits the sealing member 220 into the hollow portion 126b, the sidewall region 120 of the cap plate 100 may elastically deform, thereby instantaneously increasing the width of the hollow portion 126b in the X direction. Thereafter, when the sealing member 220 is fitted into the hollow portion 126b, the hollow portion 126b may maintain the width in the corresponding state.

FIG. 10 schematically illustrates a state in which the sealing member 220 is inserted into the electrolyte injection hole EP of the battery cell 200 according to an embodiment of the present disclosure.

As illustrated in FIGS. 5 and 10, the pressing device 300 may press-fit the sealing member 220 to a position where at least a portion of the outer surface of the sealing member 220 faces the sealed region 126a. In this case, the remaining regions of the sealing member 220 may face the plurality of notches 123. However, in the position of the sealing member 220 illustrated in FIG. 10, the plurality of notches 123 and the accommodation space 211 may be isolated from each other by the sealing member 220.

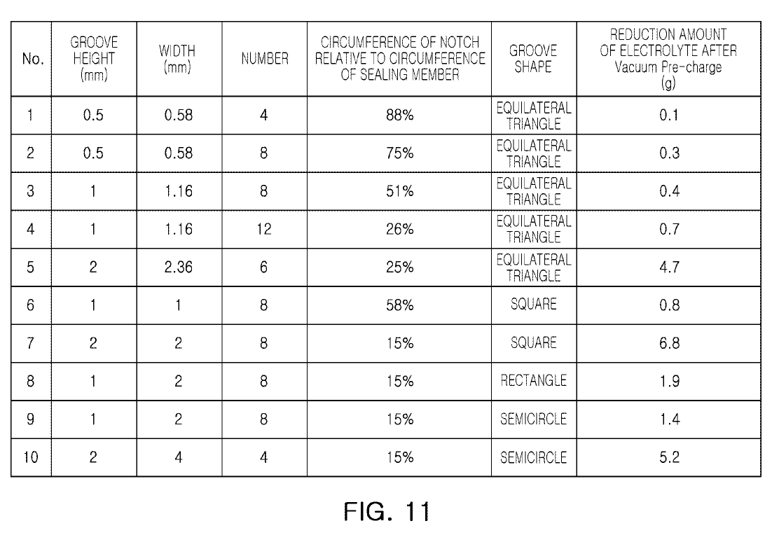

FIG. 11 illustrates test results of the battery cell 200 (FIG. 5) in which the sealing member 220 (FIG. 5) is positioned at the position illustrated in FIG. 9 and pre-charge (Pre-charge) is performed up to a pre-charge SOC of 10%, in the battery cell 200 (FIG. 5) in which the maximum width or the diameter of the sealing member 220 (FIG. 10) is 6 mm and the width 124a (FIG. 1) of the first open end portion 124 (FIG. 1) is 6 mm. In this case, the thickness of the cap plate 100 (FIG. 5) or the thickness of the body region 110 (FIG. 5) is 3 mm. As illustrated in FIGS. 1, 5, 9, and 11, the accommodation space 211 of the battery cell 200 contains the electrode assembly 201 and the electrolyte. The pressure in the accommodation space 211 is 30 Pa, and the accommodation space 211 may be in a medium vacuum state (0.1 Pa to 3000 Pa).

The state of charge (SOC) is an indicator representing the current charge state of the battery cell 200 as a percentage (%), and an SOC of 10% may indicate that the remaining energy in the battery cell 200 corresponds to 10% of the total capacity of the battery cell 200. Further, the groove shape may correspond to the shape of the notch 123 as seen from the plan view of the cap plate 100. For example, as illustrated in FIG. 2, the groove shape may correspond to the shape of the single notch 123 in the X-Z plane or cross-section.

As illustrated in FIGS. 1, 5, 6, 9 and 11, referring to the test results, when the thickness of the cap plate 100 or the thickness of the plate body region 110 is 3 mm, it may be seen that, when the depth 123bof the notch 123 is greater than or equal to 2 mm or when the maximum width 123a of the notch 123 is greater than or equal to 4 mm, the amount of electrolyte reduction g relatively increases. The increase in the amount of electrolyte reduction g indicates that the amount of electrolyte leaking or evaporating from the accommodation space 211 increases. Therefore, the amount of electrolyte reduction g needs to be maintained within a certain range. Accordingly, by considering the initially supplied amount of electrolyte and the specifications of the battery cell 200, the specifications of the notch 123 may be determined within an appropriate range.

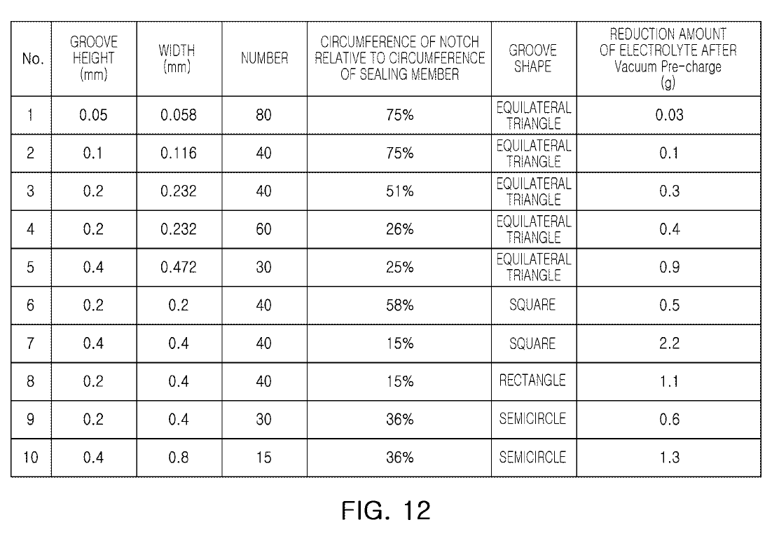

FIG. 12 illustrates test results of the battery cell 200 (FIG. 5) in which the sealing member 220 (FIG. 5) is positioned at the position illustrated in FIG. 9 and pre-charge (Pre-charge) is performed up to a pre-charge SOC of 10%, and in which the maximum width or the diameter of the sealing member 220 (FIG. 10) is 6 mm and the width 124a (FIG. 1) of the first open end portion 124 (FIG. 1) is 6 mm. In this case, the thickness of the cap plate 100 (FIG. 5) or the thickness of the plate body region 110 (FIG. 5) is 0.6mm. As illustrated in FIGS. 1, 5, 9, and 12, the accommodation space 211 of the battery cell 200 contains the electrode assembly 201 and the electrolyte. The pressure in the accommodation space 211 is 30 Pa, and the accommodation space 211 may be in a medium vacuum state (0.1 Pa to 3000 Pa).

Referring to the test results illustrated in FIGS. 1, 5, 6, 9 and 12 , when the thickness of the cap plate 100 or the thickness of the plate body region 110 is 0.6 mm, the amount of electrolyte reduction g is maintained within a certain range when the depth 123b of the notch 123 is greater than or equal to 0.05 mm and less than or equal to 0.4 mm, or when the maximum width 123aof the notch 123 is greater than or equal to 0.052 mm and less than or equal to 0.8 mm.

In addition, it can be observed that as the sum of the minimum widths 127a of the plurality of protruding regions 127 in the circumferential direction of the sealing member 220 increases, the amount of electrolyte reduction g decreases.

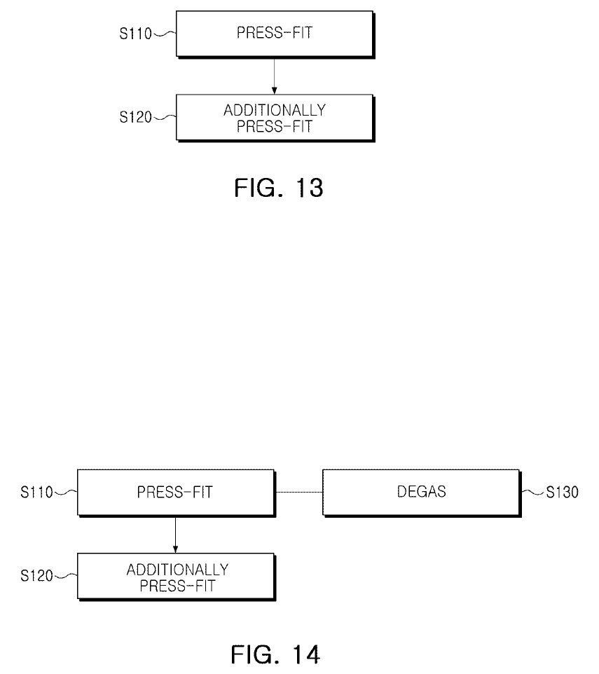

Meanwhile, according to still another embodiment of the present disclosure, there is provided a manufacturing method for a battery cell. FIG. 13 is a diagram schematically illustrating a manufacturing method for a battery cell according to an embodiment of the present disclosure.

As illustrated in. FIGS. 1 through 13, the present disclosure provides a manufacturing method for a battery cell 200 that includes the case 210 having the accommodation space 211 for receiving the electrode assembly 201, the cap plate 100 connected to the case 210 and including the electrolyte injection hole EP; and the sealing member 220 inserted into the electrolyte injection hole EP and sealing the electrolyte injection hole EP, in which the cap plate 100 includes the plate body region 110 covering the accommodation space 211 and forming the electrolyte injection hole EP by being recessed from the plate body region 110, and the sidewall region 120 having open end portions, and at least one of the sidewall region 120 and the plate body region 110 includes at least one notch 123.

The present disclosure provides a manufacturing method for a battery cell 200: including a press-fitting step in which the sealing member 220 is press-fitted such that the outer surface of the sealing member 220 faces the at least one notch 123, and an additional press-fitting step performed after the completion of the press-fitting step to adjust the height of the sealing member 220 in the electrolyte injection hole EP.

In one embodiment, at least one notch 123 may be provided as the plurality of notches 123. The plurality of notches 123 may be spaced apart from each other in the circumferential direction of the electrolyte injection hole EP or the circumferential direction of the sidewall region 120. Here, the circumferential direction of the electrolyte injection hole EP and the circumferential direction of the sidewall region 120 may be the same.

As illustrated in. FIGS. 9 and 13, the press-fitting step may be performed by press-fitting the sealing member 220 into the electrolyte injection hole EP or the hollow portion 126b using the pressing device 300.

The pressing device 300 may push the sealing member 220 into the electrolyte injection hole EP or the hollow portion 126b until at least a portion of the outer surface of the sealing member 220 faces at least one notch 123.

The pressing device 300 may stop applying pressure to the sealing member 220 when the outer surface of the sealing member 220 reaches a position where at least a portion faces at least one notch 123.

During the press-fitting step, the sidewall body portion 126 may instantaneously move in a direction in which the width of the hollow portion 126b or the electrolyte injection hole EP increases.

The sealing member 220 may be fixed in position by the force applied by the sidewall body portion 126 or by contact with the plurality of protruding regions 127 as illustrated in FIG. 6.

FIG. 14 schematically illustrates a manufacturing method for a battery cell according to one embodiment of the present disclosure. As illustrated in FIGS. 9, 13 and 14, the manufacturing method for a battery cell according to one embodiment of the present disclosure may further include a degassing step.

As illustrated in FIG. 9, the degassing step may be performed by applying a voltage to the battery cell 200 while the sealing member 220 remains in the position reached during the press-fitting step.

In an embodiment, the accommodation space 211 illustrated in FIG. 5 may be in the above-described medium vacuum state. A separate power supply device may be used to apply the voltage to the battery cell 200.

The battery cell 200 may be pre-charged up to SOC 10%. In this case, gas generated in the accommodation space 211 may be discharged to the outside of the case 210 through the plurality of notches 123. Since the sealing member 220 covers the electrolyte injection hole EP, unnecessary evaporation of the electrolyte may be minimized or prevented.

In an embodiment, the additional press-fitting step may be performed after the completion of the press-fitting step and the degassing step.

As illustrated in FIGS. 5, 10, and 14, in the additional press-fitting step, at least a partial region of the sealing member 220 may not face the plurality of notches 123, while another partial region of the sealing member 220 may contact or be closely engaged with the sealed region 126a. This may be performed by the pressing device 300. The pressing device 300 may lower the position of the sealing member 220 in the -Y direction, thereby reducing the height of the sealing member 220 relative to its position in the press-fitting step. That is, in the additional press-fitting step, the height of the sealing member 220 may be lower than its height in the press-fitting step, and in an additional press-fitting step, the sealing member 220 may move in a direction closer to the accommodation space 211.

Accordingly, the accommodation space 211 and the plurality of notches 123 are isolated from each other, and the electrolyte and gas present in the accommodation space 211 may not leak to the outside of the case 210.

According to one aspect of the present disclosure, there may be provided the cap plate for a battery cell capable of improving gas removal efficiency within a battery cell, the battery cell including the same, and the manufacturing method for the battery cell.

In addition, according to one aspect of the present disclosure, there may be provided the cap plate for a battery cell capable of improving the efficiency of a battery cell manufacturing process and the quality of the battery cell, the battery cell including the same, and the manufacturing method for the battery cell.

Furthermore, the present disclosure may be widely applied in green technology fields such as solar power generation and wind power generation.

Furthermore, the present disclosure may be applied to the eco-friendly devices such as eco-friendly electric vehicles and hybrid vehicles that suppress air pollution and greenhouse gas emissions to prevent climate change.

Only specific examples of implementations of certain embodiments are described. Variations, improvements and enhancements of the disclosed embodiments and other embodiments may be made based on the disclosure of this patent document.

What is claimed is:

1. A cap plate of a battery cell, comprising:
a plate body region; and
a sidewall region recessed in the plate body region to form an electrolyte injection hole and having open end portions,
wherein at least one of the sidewall region and the plate body region includes at least one notch.

2. The cap plate of claim 1, further comprising:
a plurality of notches,
wherein the plurality of notches are formed in the sidewall region and the plate body region and formed in a circumferential direction of the sidewall region.

3. The cap plate of claim 2, wherein the plurality of notches are spaced apart from each other in the circumferential direction of the sidewall region.

4. The cap plate of claim 1, wherein a shape of the at least one notch in a cross-section of the sidewall region in a thickness direction is a polygon.

5. The cap plate of claim 1, wherein a shape of the at least one notch in a cross-section of the sidewall region in a thickness direction is an arc.

6. The cap plate of claim 1, wherein the end portions of the sidewall region include:
a first open end portion connected to the plate body region; and
a second open end portion spaced apart from the first open end portion, and
the sidewall region includes a sidewall body portion connecting the first open end portion and the second open end portion and forming a hollow portion.

7. The cap plate of claim 6, wherein a width of the first open end portion is wider than that of the second open end portion.

8. The cap plate of claim 6, wherein at least a partial region of the at least one notch is disposed at the same height as the first open end portion.

9. The cap plate of claim 8, wherein the sidewall body portion includes a sealed region which is a region where the at least one notch is not formed, and
the sealed region is a region from the second open end portion to the at least one notch.

10. A battery cell, comprising:
a case including an accommodation space in which an electrode assembly is accommodated;
a cap plate connected to the case and including an electrolyte injection hole; and
a sealing member inserted into the electrolyte injection hole,
wherein the cap plate includes:
a plate body region covering the accommodation space; and
a sidewall region recessed in the plate body region to form the electrolyte injection hole and having open end portions,
at least one of the sidewall region and the plate body region includes at least one notch, and
the sealing member seals the electrolyte injection hole.

11. The battery cell of claim 10, wherein the at least one notch includes a plurality of notches,
the end portions of the sidewall region include:
a first open end portion connected to the plate body region; and
a second open end portion spaced apart from the first open end portion,
the sidewall region includes a sidewall body portion connecting the first open end portion and the second open end portion and forming a hollow portion, and
the sealing member is disposed in the hollow portion.

12. The battery cell of claim 11, wherein the sidewall body portion includes a sealed region which is a region where a plurality of notches are not formed,
the sealed region is a region from the second open end portion to the plurality of notches, and
at least a partial region of the sealing member is in contact with the sealed region.

13. The battery cell of claim 11, wherein a width of the first open end portion is wider than a maximum width of the sealing member, and
a width of the second open end portion is narrower than the maximum width of the sealing member.

14. The battery cell of claim 13, wherein a width of the hollow portion linearly decreases toward the second open end portion.

15. The battery cell of claim 11, wherein the sidewall region further includes a plurality of protruding regions alternately disposed with the plurality of notches in a circumferential direction of the sidewall region, and
a sum of minimum widths of the plurality of protruding regions in the circumferential direction of the sealing member is greater than or equal to 10% and less than or equal to 90% of a circumference value of the sealing member.

16. The battery cell of claim 11, wherein a width of the plurality of notches decreases as the plurality of notches move away from the hollow portion.

17. The battery cell of claim 16, wherein the plurality of notches each have a maximum width at a region closest to the hollow portion, and
the maximum width is greater than or equal to 0.04 mm and less than or equal to 2 mm.

18. The battery cell of claim 17, wherein a depth of the plurality of notches is greater than or equal to 0.04 mm and less than 2 mm.

19. A manufacturing method for a battery cell including a case including an accommodation space in which an electrode assembly is accommodated, a cap plate connected to the case and including an electrolyte injection hole, and a sealing member inserted into the electrolyte injection hole and sealing the electrolyte injection hole, the cap plate including a plate body region covering the accommodation space, and a sidewall region recessed in the plate body region to form the electrolyte injection hole and having open end portions, and at least one of the sidewall region and the plate body region including at least one notch, the manufacturing method comprising:
performing a press-fitting in which the sealing member is press-fitted to a position where an outer surface of the sealing member faces the at least one notch; and
performing an additional press-fitting after the press-fitting, in which a height of the sealing member in the electrolyte injection hole is changed.

20. The manufacturing method of claim 19, further comprising:
performing a degassing in which a voltage is applied to the battery cell while the sealing member is at a position corresponding to a position in the press-fitting.
